(19) United States
(12) Patent Application Publication
(10) Pub. No.: US 2005/0288913 A1
(43) Pub. Date: Dec. 29, 2005

(54) Circuit design simulation

(76) Inventors: Gaurav Rameshbhai Shah, Caldwell, ID (US); Denise Susan Man, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/874,522

(22) Filed: Jun. 23, 2004

(51) Int. Cl. G06F 17/50

(52) U.S. Cl. 703/14

(57) ABSTRACT

An example embodiment of an approach to circuit design simulation involves runtime configuration of a circuit design simulator. The circuit design simulator is configured with initial configuration parameter values. The configured circuit design simulator is used to simulate a circuit design, with results of the simulation being stored. When runtime configuration parameter values are updated during the simulation, the circuit design simulator is reconfigured with the runtime configuration parameter values. The circuit design simulation is continued with the runtime configuration parameter values, and results of the continuing simulation are stored.

### BACKGROUND

Circuit designs are generally created and implemented using tools that generate information that is stored in one or more data storage arrangements. Storing circuit design information typically involves storing sufficient information for each design component that identifies characteristics and connectivity for all components in the circuit design. For instance, many typical circuit designs employ a multitude of FETs (field-effect transistors) and NETs (information describing the connectivity of the FETs) that define functional circuits. These FETs and NETs are typically arranged with a hierarchical relationship, with different FETs and NETs being attributed to a multitude of blocks and sub-blocks (or child blocks) that define the circuit design.

Once circuit design information is stored, simulation tools can access the design information for simulation purposes (e.g., analysis and testing). For example, circuit recognition and verification are two approaches that involve access to stored design data for simulation purposes. Some of these purposes include identifying components and connectivity for a design (circuit recognition) and verifying the operation of the design under certain conditions (circuit verification). Typically, circuit design information is input in the form of a netlist, analyzed and its logical circuit classification is output. Simulation tools use this logical circuit classification in simulating operation of the logical circuit.

Tools used to simulate circuits typically employ circuit recognition/verification functions that rely upon certain parameters for simulating the circuit design. The tool (or processor) that is simulating the circuit design uses parameters such as the IP address of the database server that stores simulation results, debugging parameters and others to carry out the simulation. These parameters are generally set prior to simulating the circuit design and are generally unchangeable during the simulation.

The generally fixed nature of the simulation parameters has presented challenges to the flexible simulation of circuit design data.

### SUMMARY

According to an example embodiment of the present invention, a circuit design is simulated using an approach involving configuration using runtime configuration parameters during a simulation run. A circuit design simulator is configured with initial configuration parameter values. A circuit design is simulated using the circuit design simulator and results of the simulation are stored. In response to an update of runtime configuration parameter values made during the simulation, the circuit design simulator is reconfigured with the runtime configuration parameter values. Simulation of the circuit design is continued with the reconfigured circuit design simulator, with results of the continuing simulation being stored.

It will be appreciated that various other embodiments are set forth in the Detailed Description and claims that follow.

### BRIEF DESCRIPTION OF THE DRAWINGS

FIG. 1 is a flow diagram for an approach to simulating a circuit design using runtime configuration parameters, according to an example embodiment of the present invention;

FIG. 1A is another flow diagram for an approach to simulating a circuit design, according to another example embodiment of the present invention;

FIG. 2 shows a circuit design simulation arrangement implemented with runtime configuration files, according to another example embodiment of the present invention;

FIG. 3 is a flow diagram for an approach to simulating a circuit design, according to another example embodiment of the present invention; and

FIG. 4 is a flow diagram for an approach to debugging errors during circuit design simulation, according to another example embodiment of the present invention.

### DETAILED DESCRIPTION

According to an example embodiment of the present invention, circuit design data is simulated as a function of configuration parameters implemented using a runtime configuration file that can be updated during simulation. Certain simulation configuration parameters are stored in the runtime configuration file for use by a simulation tool. The simulation tool accesses the runtime configuration file during a particular stage of a simulation and uses parameters stored therein to configure the simulation. When configuration parameters in the runtime configuration file are updated, the simulation tool uses these updated parameters upon the next time that the simulation tool accesses the runtime configuration file. In this regard, certain configuration parameters can be changed during a particular simulation.

According to another example embodiment of the present invention, the approach involving a runtime configuration file discussed above may be implemented in a simulation tool as follows. The simulation tool is programmed to access configuration parameters at certain stages of a particular simulation. These stages are processed in a loop, with the simulation tool exiting the loop upon completion of a particular function. When the simulation tool enters the loop, it checks to see if a runtime configuration file is available. If the runtime configuration file is available, the simulation tool uses parameters stored in the runtime configuration file to carry out the simulation. If no configuration file is available (or if any available runtime configuration file is not applicable), the simulation tool uses parameters set before the simulation. In this regard, when the simulation tool is not in the loop (e.g., before accessing the loop or after successful completion of the loop), parameters can be set and/or changed in the runtime configuration file. When the simulation tool enters the loop again, the set and/or changed parameters in the runtime configuration file are implemented.

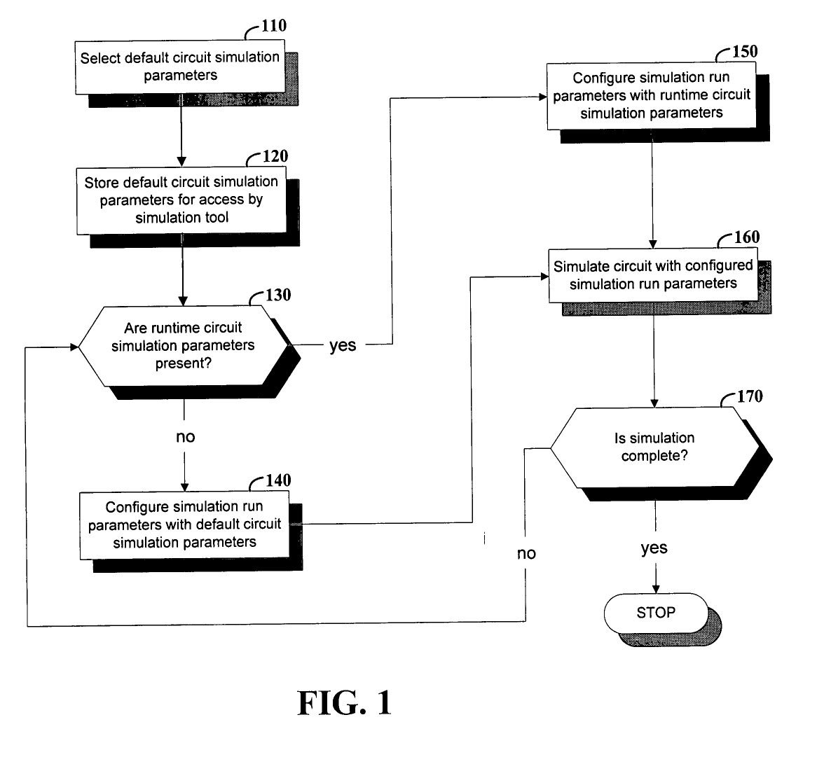

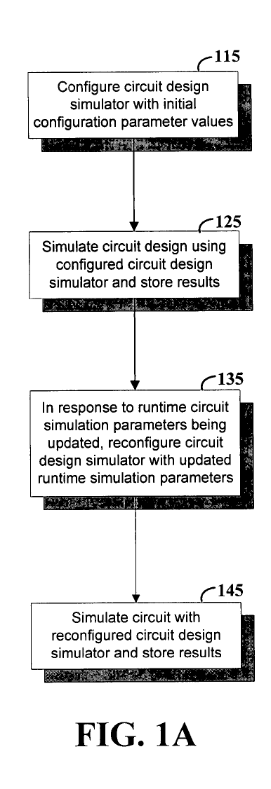

Turning now to the figures, FIG. 1 shows a flow diagram for an approach to circuit design simulation, according to another example embodiment of the present invention. At block 110, default circuit simulation parameters are selected (e.g., the parameters are input by a user and stored in a memory accessible by simulation circuitry). These default circuit simulation parameters may include one or more of a variety of types and values of parameters that are used for circuit simulation. For instance, parameters can be set for configuring data storage by providing an address of a particular database server for storing simulation results. Another parameter type that can be set involves the use of debug flags; debug flags can be used, e.g., for indicating whether debug information accumulated during simulation should be written to a log file. Debug flags can be set, for example, in response to an error or at any time when information regarding the simulation is desired. These and other simulation parameters can be selected at block 110. At block 120, the default simulation parameters are stored in memory for access by a simulation tool, and the simulation tool is now ready to enter into a simulation run such as circuit recognition.

When a simulation run is processed, a runtime configuration file is checked at block 130. If runtime circuit simulation parameters are present in the runtime configuration file, the parameters are used to configure the simulation run parameters at block 150. If runtime circuit simulation parameters are not present in the runtime configuration file at block 130, the default parameters input at block 110 are used to configure the simulation run parameters at block 140.

Once the simulation run parameters are configured, the circuit is simulated at block 160 using those parameters. The simulation may involve one or more of a variety of functions. In some instances, the simulation may involve a circuit recognition-type function in which characteristics of a circuit being simulated are identified for facilitating the simulation. For example, where a particular circuit design block is to be analyzed, the block is partitioned into functional circuits that include a combination of circuit elements (e.g., a combination of FETs). These partitions are analyzed to determine a logical circuit classification (or classifications) that characterize the partition (i.e., the circuit type of the combination is recognized). These classifications include a functional description of the combination of individual circuit elements that function together to make a particular functional circuit. Various simulation functions, such as those implemented to determine circuit timing characteristics, circuit impedance and others can then be carried out using the circuit recognition results.

If the simulation is not complete at block 170, at one or more various stages in the simulation process, the presence of runtime circuit simulation parameters is re-checked at block 130. If runtime circuit simulation parameters have been added or changed (e.g., with a new runtime configuration file), they are used to configure the simulation run at block 150 as discussed above. Accordingly, if runtime configuration parameters were previously present (and remain unchanged), the simulation continues to operate using current parameter values. Similarly, if the simulation run is configured with default configuration parameters and runtime configuration parameters are not present upon re-checking at block 130, simulation continues with the default circuit simulation parameter values. If the simulation run is configured with runtime configuration parameters but those parameters have been deleted (and not replaced) at block 130, the simulation run is configured at block 140 with default circuit simulation parameters at block 140. The simulation run then continues until block 170 is reached and the run is complete.

FIG. 1A shows a flow diagram for another approach to simulating a circuit design, according to another example embodiment of the present invention. At block 115, a circuit design simulator is configured with initial configuration parameter values. At block 125, the circuit design is simulated using the configured circuit design simulator and the results of the simulation are stored. In response to an update to runtime configuration parameter values being made during the simulation at block 143, the circuit design simulator is reconfigured with the runtime configuration parameter values. At block 145, the circuit design is simulated using the reconfigured circuit design simulator and the results are stored.

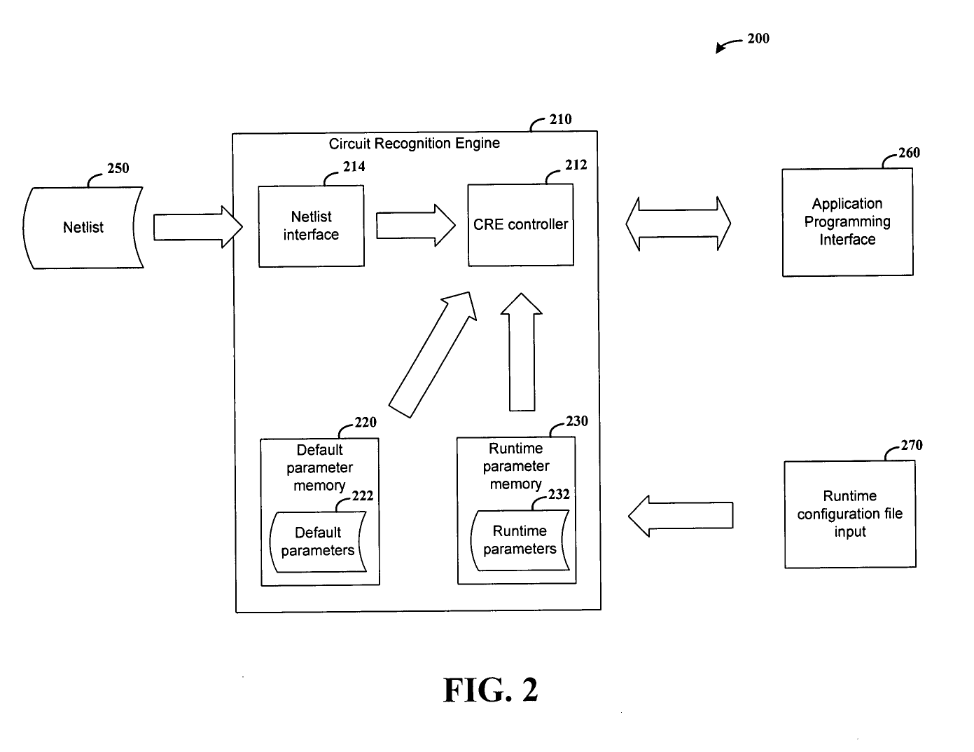

FIG. 2 shows a circuit design simulation arrangement 200 including a circuit recognition engine (CRE) 210 implemented with runtime configuration files, according to another example embodiment of the present invention. The CRE 210 includes a CRE controller 212 for controlling functions of the CRE 210 in response to inputs from an application programming interface (API) 260. The CRE 210 further includes a netlist interface 214 adapted to interact with a netlist 250, shown here by way of example and optionally implemented with a plurality of netlists, for retrieving netlist data for a circuit design.

Two parameter memories, optionally physically or logically separate from the CRE 210, are shown implemented as a default parameter memory 220 and a runtime parameter memory 230 are coupled with the CRE controller 212 for supplying circuit recognition parameters. The default parameter memory 220 is adapted for storing default configuration parameters 222 for use in processing information retrieved from the netlist 250. In some instances, the default configuration parameters 222 include information for selecting a particular source, represented by netlist 250, from which to retrieve circuit design information. The runtime parameter memory 230 is adapted for selectively storing runtime configuration parameters 232 that can be changed and/or deleted during a circuit recognition run of the circuit recognition engine 210.

A runtime configuration file input 270 is adapted for storing runtime configuration parameters 232 in the runtime parameter memory 230. In some instances, the runtime configuration input 270 is also implemented to modify and/or delete existing runtime configuration parameters 232. The runtime configuration file input 270 is also optionally implemented with the API 260.

The CRE controller 212 may be implemented in one or more of a variety of manners, such as those discussed above in connection with FIG. 1 and otherwise. In one particular implementation, the CRE controller 212 implements configuration parameters for circuit recognition as follows. If runtime configuration parameters 232 are present in the runtime parameter memory 230, the CRE controller 212 uses the runtime configuration parameters. If runtime configuration parameters 232 are not present in the runtime parameter memory 230, the CRE controller uses the default configuration parameters 222.

In addition, at various checkpoints in the simulation process, the CRE controller 212 checks to see whether a change has occurred with the status of runtime configuration parameters 232. These checkpoints can be implemented automatically, at a particular interval and/or at the inception of a particular process. If runtime configuration parameters 232 were not previously present, such that the default configuration parameters 222 are being used at a checkpoint, but runtime configuration parameters 232 have been added, the CRE controller 212 uses the newly-added runtime configuration parameters. If runtime configuration parameters 232 were previously present (and used in circuit recognition) but are not present at a checkpoint (e.g., have been deleted), the default configuration parameters 222 are implemented for circuit recognition. Furthermore, if runtime configuration parameters 232 were previously present but have been updated at a checkpoint, the CRE controller 212 uses the updated configuration parameters to process circuit recognition.

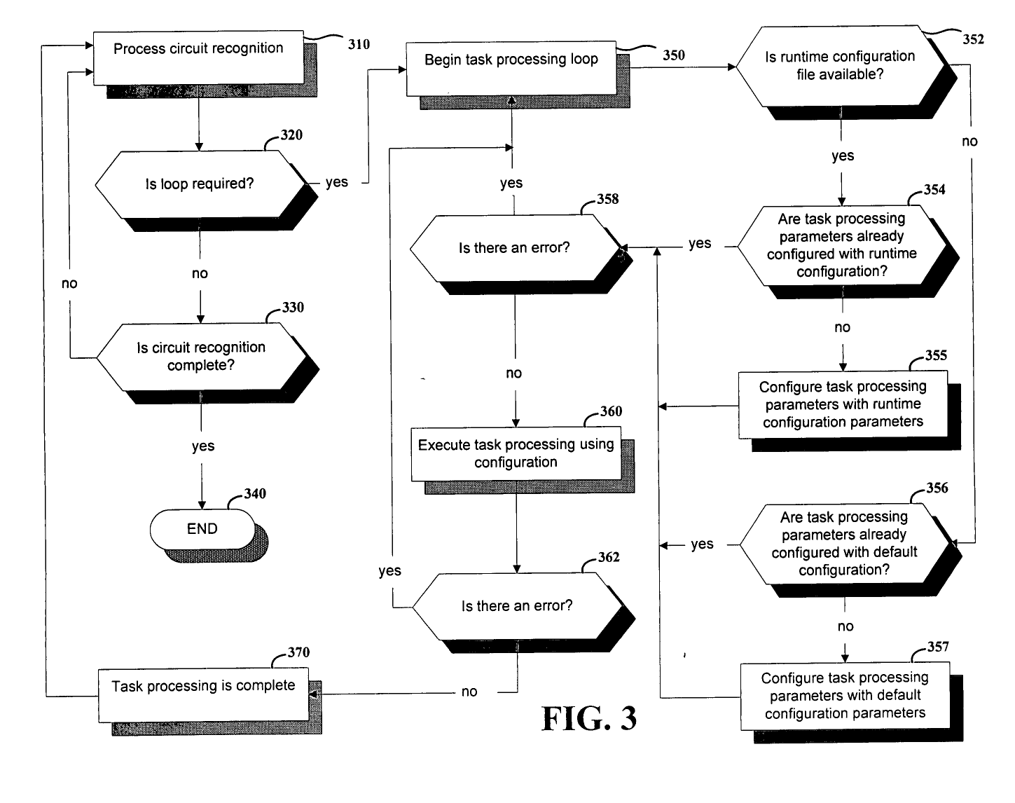

FIG. 3 is a flow diagram for an approach to simulating a circuit design, according to another example embodiment of the present invention. The implementation shown in the flow diagram uses a task loop that relies upon configuration parameters for execution of circuit recognition functions. The circuit recognition involves the identification (recognition) of groups of circuit elements taken from a netlist. When a particular grouping of circuit elements (e.g., transistors) is recognized as a particular known functional circuit (inverter, etc.), the functional circuit is named accordingly. The named functional circuit can then be implemented for simulation purposes by associating the name with the functionality of the known functional circuit. In some implementations, the circuit recognition discussed with FIG. 3 further involves the partitioning of a circuit design (or block thereof) into the above-mentioned groups of circuit elements that can be recognized as a known functional circuit.

At block 310, a circuit recognition process is initiated using one or more of the approaches discussed above. If a loop (i.e., a particular circuit recognition function loop) is not required at block 320, and if circuit recognition is complete at block 330, the process ends at block 340. If the loop is not required at block 320 but circuit recognition is not complete at block 330, the process continues at block 310.

If the loop is required at block 320, a task processing loop is begun at block 350. If a runtime configuration file is available at block 352 (i.e., if a runtime configuration file has been stored in a memory accessible by the loop), runtime configuration is used. If task processing parameters are already configured with runtime configuration parameters in the runtime configuration file at block 354, reconfiguration is not necessary. If task processing parameters are not configured with the runtime configuration parameters in the runtime configuration file at block 354 (i.e., the runtime configuration file has been updated or newly presented), task processing parameters are configured at block 355 with the runtime configuration parameters. Once runtime configuration has been set (or maintained), the process continues at block 358, discussed further below. In some instances, the runtime configuration parameters made available via a runtime configuration file are read from the file stored locally for use by a simulation program, with updates to the locally stored parameters being made in connection with block 355.

If a runtime configuration file is not available at block 352, a default configuration is used. If task processing parameters are already configured with the default configuration parameters at block 356, reconfiguration is not necessary. If task processing parameters are not configured with the default configuration parameters at block 356, the task processing parameters are configured at block 357 with the default configuration parameters. This default configuration may involve, for example, situations where previously implemented runtime configuration parameters are deleted, or when an initial configuration is set. These default configuration parameters may be stored in a default parameter memory accessible by the task loop and set prior to initiation of the circuit recognition process at block 310. Once default configuration is set (or maintained), the process continues at block 358, discussed below.

The task processing loop is further adapted for error checking at various points in the process and includes, as represented by block 358, a check for an error after task processing parameters have been configured (with runtime or default parameters). These errors may include those associated with, for example, writing processing results to a particular database, reading information from a database for use in processing, corrupt data such as configuration data and others. If there is an error at block 358, the task processing loop is restarted at block 350. If there is no error at block 358, task processing is executed using the configured task processing parameters. Error checking is again implemented at block 362, with the task processing loop being restarted at block 350 in the event of an error. If an error is not found at block 362, the task processing loop is exited (and completed) at block 370, with circuit recognition processing continuing at block 310. With this approach, runtime errors can be addressed without necessarily voiding or otherwise harming an entire simulation run; users have an opportunity to address errors by changing runtime configuration files, with the particular loop completing upon correction of the error.

In one implementation, an error signal is set in connection with errors detected at either block 358 or 362. In some instances, this error signal includes a signal recognizable by an automated error correction type process that automatically updates runtime configuration files to address the error. In other instances, the error signal presents a user-recognizable signal, such as an email, that can be detected by a user. Upon notification of an error condition, a user can selectively change runtime configuration parameters. Accordingly, updated parameters are stored in a runtime configuration file that is made available and implemented in connection with blocks 352 and 354.

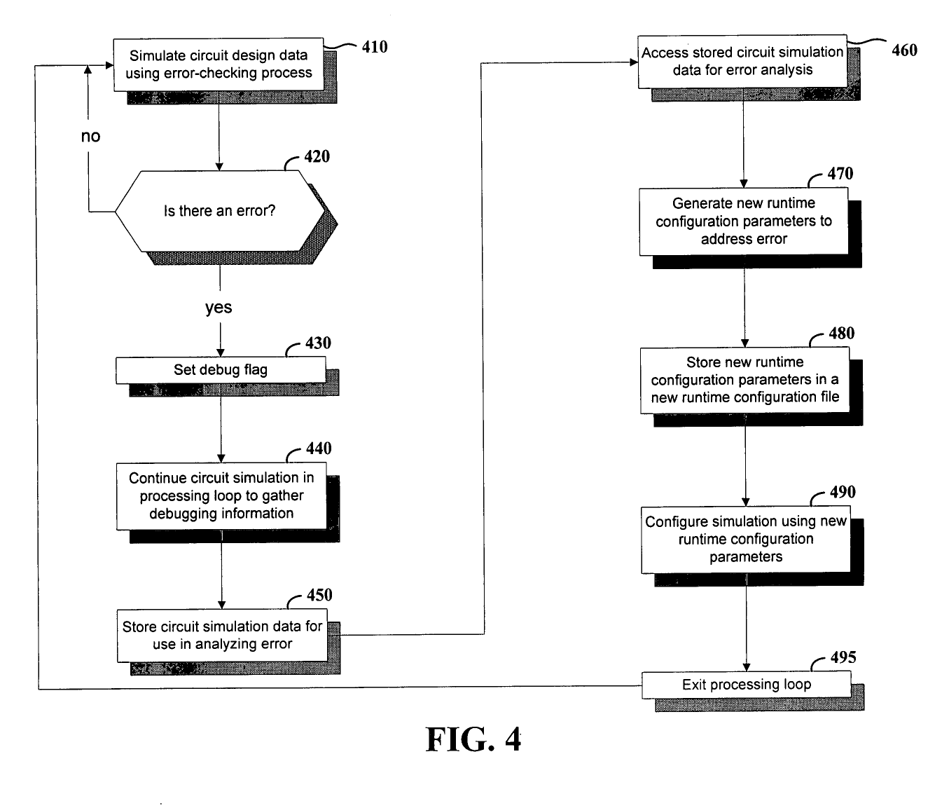

FIG. 4 shows a debugging process in which one or more errors that occur during a circuit simulation run are debugged. This approach shown in FIG. 4 may be implemented, for example, in connection with the error checking shown in FIG. 3 at blocks 358 and 362. Upon completion of the debug process, new runtime configuration files can be stored and implemented in connection with blocks 352 and 354.

Simulation is carried out on a circuit design at block 410. An error check is performed at block 420 and, if no error exists, the simulation is continued at block 410. If there is an error at block 420, a debug flag is set at block 430 to configure a processor performing the simulation to store debugging information. Such debugging information may include, for example, processing results generated in error, error codes identifying a particular problem (e.g., an error message indicating an inability to write to or read from a particular database, or a corrupt data message). The setting of the debug flag at block 430 may also involve generating an alert for alert a user (or automated monitor) that an error has occurred, such as by sending an email or other type of informative signal.

Circuit simulation is continued in a processing loop at block 440 to gather debugging information, with circuit simulation data being stored at block 450 for use in analyzing the error. This circuit simulation data may include, for example, error messages or general circuit simulation data that can be used in further evaluating characteristics of the simulation that are related to the error. At block 460, the stored circuit simulation data is accessed for error analysis; a user retrieves the data and manually or automatically reviews the data to review errors and determine potentially error-causing conditions or configuration. At block 470, new runtime configuration parameters are generated to address the error and the new runtime configuration parameters are stored in a runtime configuration file at block 480. This runtime configuration file may be implemented for use as discussed, for example, in connection with block 352 and others in connection with FIG. 3.

The simulation is configured at block 490 using the new runtime configuration parameters, and the processing loop is exited at block 495. This processing loop exit at block 495 may, for example, be implemented after an error-causing process has been successfully completed using the new runtime configuration parameters, as discussed above in connection with FIG. 3 (e.g., task processing has been completed). The process then continues at block 410, with simulation of the circuit design progressing towards completion while continuing to check for errors.

In another implementation, the runtime configuration file in which the new runtime configuration parameters are stored at block 480 is deleted after the simulation is configured using the new runtime configuration parameters at block 490. This can reduce unnecessary checks for runtime configuration parameter updates during subsequent circuit simulation (e.g., such that the runtime configuration file does not need to be checked as discussed with block 352 in FIG. 3).

Those skilled in the art will appreciate that various alternative computing arrangements would be suitable for hosting the approaches of the different embodiments of the present invention. In addition, the approaches may be implemented via a variety of computer-readable media or delivery channels such as magnetic or optical disks or tapes, electronic storage devices, or as application services over a network.

The present invention is believed to be applicable to a variety of circuit design simulation arrangements and approaches and has been found to be particularly applicable and beneficial for use with circuit design data simulation for use with circuit recognition and verification-type implementations. In addition, the present invention has been found applicable to linear, sequential and traditional (e.g., non-event-driven) programming implementations that are not generally amenable to runtime configuration. These non-event-driven programming implementations typically must actively detect error conditions, following a control flow pattern and only with intermittent flow pattern changes at branch points. Relative to event-driven programming, which can passively respond to an external error event, the active response required by non-event-driven programming approaches can be implemented using the loop and detection approaches discussed hereinabove.

Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

1. A method for simulating a circuit design, the method comprising:
configuring a circuit design simulator with initial configuration parameter values;
simulating a circuit design using the circuit design simulator and storing results of the simulation;
in response to an update of runtime configuration parameter values made during the simulation, reconfiguring the circuit design simulator with the runtime configuration parameter values; and
after reconfiguring the circuit design simulator, continuing simulation of the circuit design and storing results of the continuing simulation.

2. The method of claim 1, wherein simulating a circuit design and continuing simulation of the circuit design include running circuit recognition on the circuit design.

3. The method of claim 2, wherein reconfiguring the circuit design simulator with the runtime configuration parameter values includes setting circuit recognition parameters to the runtime configuration parameters.

4. The method of claim 2, wherein running circuit recognition on the circuit design includes determining a functional classification of a plurality of circuit elements of the circuit design.

5. The method of claim 4, wherein determining a functional classification of a plurality of circuit elements includes determining a functional classification of a combination of the plurality of circuit elements by identifying the combination as making up a particular functional circuit and assigning a property to the combination that characterizes the particular functional circuit.

6. The method of claim 2, wherein running circuit recognition on the circuit design includes partitioning a circuit block into functional circuits that include a combination of circuit elements.

7. The method of claim 1, wherein the circuit design simulator is implemented with non-event-driven programming.

8. The method of claim 7, wherein the circuit design simulator is implemented with non-event-driven programming having a predefined processing path and wherein, in response to an update of runtime configuration parameter values made during the simulation, reconfiguring the circuit design simulator with the runtime configuration parameter values includes executing a predefined programming loop that checks to see if runtime configuration parameter values have been updated.

9. The method of claim 8, wherein executing a predefined programming loop includes executing a predefined programming loop that checks for an error condition and, upon detection of an error condition, remains in the loop until the error condition is resolved.

10. The method of claim 1, wherein the steps of simulating a circuit design, reconfiguring the circuit design simulator and continuing simulation of the circuit design are carried out in a processing loop comprising the steps of:
checking to see if a runtime configuration file is present;
in response to a runtime configuration file not being present, simulating the circuit design using the circuit design simulator configured with the initial configuration values;
in response to a runtime configuration file being present:
checking to see if configuration parameter values in the runtime configuration file are updated, relative to configuration parameter values that the circuit design simulator is configured with;
in response to configuration parameter values in the runtime configuration file being updated, configuring the circuit design simulator with the runtime configuration parameter values; and
simulating the circuit design with the circuit design simulator configured with runtime configuration parameter values; and
after simulating the circuit design, exiting the processing loop.

11. The method of claim 10, wherein simulating the circuit design using the circuit design simulator configured with the initial configuration values in response to a runtime configuration file not being present includes:
in response to the circuit design simulator being configured with runtime configuration files, reconfiguring the circuit design simulator with the initial configuration values, prior to simulating the circuit design using the circuit design simulator configured with the initial configuration values.

12. The method of claim 10, wherein the processing loop further comprises the steps of:
in response to an error, repeating the processing loop until the error has been corrected, prior to exiting the processing loop.

13. The method of claim 12, further comprising:
in response to an error, generating an error signal for a user;
in response to the error signal, generating new runtime configuration parameters and storing the parameters in a new runtime configuration file; and
wherein repeating the processing loop includes, in response to the new runtime configuration file, configuring the circuit design simulator with the new runtime configuration parameter values and simulating the circuit design with the circuit design simulator configured with the new runtime configuration files.

14. The method of claim 13, further comprising:
setting a debug flag in response to the error; and
wherein repeating the processing loop includes, in response to the debug flag, storing debugging information and using the debugging information to generate the new runtime configuration parameters.

15. A system for simulating a circuit design, the system comprising:
means for configuring a circuit design simulator with initial configuration parameter values;
means for simulating a circuit design and storing results of the simulation;
means, responsive to an update of runtime configuration parameter values made during the simulation, for reconfiguring the circuit design simulator with the runtime configuration parameter values; and
means for continuing simulation of the circuit design and storing results of the continuing simulation after reconfiguring the circuit design simulator.

16. A system for simulating a circuit design, the system comprising:
a circuit configurator adapted to configure a circuit design simulator with initial configuration parameter values;
a circuit simulator adapted to simulate a circuit design and store results of the simulation;
the circuit configurator being further adapted, in response to an update of runtime configuration parameter values made during the simulation, to reconfigure the circuit design simulator with the runtime configuration parameter values; and
the circuit simulator being further adapted to continue simulation of the circuit design and store results of the continuing simulation after the circuit design simulator has been reconfigured.

17. The system of claim 16, wherein the circuit simulator is further adapted to simulate the circuit design by running circuit recognition on the circuit design.

18. The system of claim 16, further comprising an error checker adapted to check for an error during simulation of the circuit design and wherein, in response to the error checker detecting an error, the system is adapted to operate in an error loop until the error has been resolved.

19. The system of claim 18, wherein the circuit configurator is adapted to check for updated runtime configuration parameter values upon each iteration of the error loop and wherein the system is adapted to exit the error loop upon resolution of the error via the circuit simulator being reconfigured with the updated runtime configuration parameter values.

20. A program storage device, comprising:
a processor-readable medium configured with instructions executable by the processor for demoting a page in virtual memory by performing the operations of:
configuring a circuit design simulator with initial configuration parameter values;
simulating a circuit design using the circuit design simulator and storing results of the simulation;
in response to an update of runtime configuration parameter values made during the simulation, reconfiguring the circuit design simulator with the runtime configuration parameter values; and
after reconfiguring the circuit design simulator, continuing simulation of the circuit design and storing results of the continuing simulation.

21. The device of claim 20, wherein the processor-readable medium is further configured with instructions executable by the processor for demoting a page in virtual memory by performing the operations of simulating a circuit design and continuing simulation of the circuit design by running circuit recognition on the circuit design.

22. The device of claim 21, wherein the processor-readable medium is further configured with instructions executable by the processor for demoting a page in virtual memory by performing the operation of reconfiguring the circuit design simulator with the runtime configuration parameter values by setting circuit recognition parameters to the runtime configuration parameters.

23. The device of claim 21, wherein the processor-readable medium is further configured with instructions executable by the processor for demoting a page in virtual memory by performing the operation of running circuit recognition on the circuit design by determining a functional classification of a plurality of circuit elements of the circuit design.

24. The device of claim 23, wherein the processor-readable medium is further configured with instructions executable by the processor for demoting a page in virtual memory by performing the operations of determining a functional classification of a plurality of circuit elements by determining a functional classification of a combination of the plurality of circuit elements by identifying the combination as making up a particular functional circuit and by assigning a property to the combination that characterizes the particular functional circuit.

25. The device of claim 21, wherein the processor-readable medium is further configured with instructions executable by the processor for demoting a page in virtual memory by performing the operations of running circuit recognition on the circuit design by partitioning a circuit block into functional circuits that include a combination of circuit elements.

26. The device of claim 20, wherein the processor-readable medium is further configured with instructions executable by the processor for demoting a page in virtual memory by performing the operations of simulating a circuit design and continuing simulation of the circuit design by implementing non-event-driven programming.

27. The device of claim 26, wherein the processor-readable medium is further configured with instructions executable by the processor for demoting a page in virtual memory by implementing non-event-driven programming having a predefined processing path and, in response to an update of runtime configuration parameter values made during the simulation, for performing the operations of reconfiguring the circuit design simulator with the runtime configuration parameter values by executing a predefined programming loop that checks to see if runtime configuration parameter values have been updated.

28. The device of claim 27, wherein the processor-readable medium is further configured with instructions executable by the processor for demoting a page in virtual memory by performing the operations of executing a predefined programming loop by executing a predefined programming loop that checks for an error condition and, upon detection of an error condition, remains in the loop until the error condition is resolved.

29. The device of claim 20, wherein the processor-readable medium is further configured with instructions executable by the processor for demoting a page in virtual memory by performing the steps of simulating a circuit design, reconfiguring the circuit design simulator and continuing simulation of the circuit design by carrying out a processing loop comprising the steps of:
checking to see if a runtime configuration file is present;
in response to a runtime configuration file not being present, simulating the circuit design using the circuit design simulator configured with the initial configuration values;
in response to a runtime configuration file being present:
checking to see if configuration parameter values in the runtime configuration file are updated, relative to configuration parameter values that the circuit design simulator is configured with;
in response to configuration parameter values in the runtime configuration file being updated, configuring the circuit design simulator with the runtime configuration parameter values; and
simulating the circuit design with the circuit design simulator configured with runtime configuration parameter values; and
after simulating the circuit design, exiting the processing loop.

30. The device of claim 29, wherein the processor-readable medium is further configured with instructions executable by the processor for demoting a page in virtual memory by performing the operations of simulating the circuit design using the circuit design simulator configured with the initial configuration values in response to a runtime configuration file not being present by:
in response to the circuit design simulator being configured with runtime configuration files, reconfiguring the circuit design simulator with the initial configuration values, prior to simulating the circuit design using the circuit design simulator configured with the initial configuration values.

31. The device of claim 29, wherein the processor-readable medium is further configured with instructions executable by the processor for demoting a page in virtual memory by performing the operations of, in response to an error, repeating the processing loop until the error has been corrected, prior to exiting the processing loop.

32. The device of claim 31, wherein the processor-readable medium is further configured with instructions executable by the processor for demoting a page in virtual memory by performing the operations of:
in response to an error, generating an error signal for a user;
in response to the error signal, generating new runtime configuration parameters and storing the parameters in a new runtime configuration file; and
repeating the processing loop by, in response to the new runtime configuration file, configuring the circuit design simulator with the new runtime configuration parameter values and simulating the circuit design with the circuit design simulator configured with the new runtime configuration files.

33. The device of claim 32, wherein the processor-readable medium is further configured with instructions executable by the processor for demoting a page in virtual memory by performing the operations of:
setting a debug flag in response to the error; and
repeating the processing loop by, in response to the debug flag, storing debugging information and using the debugging information to generate the new runtime configuration parameters.
